(19) United States
(12) Patent Application Publication
(10) Pub. No.: US 2026/0098688 A1
(43) Pub. Date: Apr. 9, 2026

(54) THERMAL ENERGY STORAGE SYSTEM AND RELATED METHODS

(71) Applicant: National Power Authority, Inc., Saint Ansgar, IA (US)

(72) Inventor: Matthew N. Schwarck, Saint Ansgar, IA (US)

(21) Appl. No.: 19/352,117

(22) Filed: Oct. 7, 2025

Related U.S. Application Data
(60) Provisional application No. 63/704,448, filed on Oct. 7, 2024.

(51) Int. Cl. F28D 20/00

(52) U.S. Cl. CPC F28D 20/0056; F27M 2003/03

(57) ABSTRACT

A thermal energy storage system and related methods of storing thermal energy in the form of sensible heat, the thermal energy converted from an input energy source, such as s renewable energy source, to thermal energy stored in a sensible heat storage medium that includes calcium oxide that can optionally be produced from a source of calcium carbonate, such as limestone from a local quarry, whereby the thermal energy charged within the sensible heat storage medium can be stored until a desired time whereby discharging of the thermal energy can be conducted to transfer the thermal energy to an output energy source, such as using a working fluid.

### PRIORITY CLAIM

This present invention claims priority to U.S. Provisional Application No. 63/704,448 filed Oct. 7, 2024, which is hereby incorporated by reference in its entirety.

### TECHNICAL FIELD

The present invention relates to a thermal energy storage system and related methods of storing thermal energy in the form of sensible heat, more particularly a thermal energy storage system and related methods using calcium oxide as the primary thermal storage medium, whereby the calcium oxide (CaO) can be produced from a source of calcium carbonate (CaCO₃).

### BACKGROUND

Fossil fuels have been the primary source of energy production since the beginning of the industrial revolution in the nineteenth century. With the increase of worldwide consumption and concern of the long-term effects of relying upon fossil fuels, there has been a rapid energetic transition to renewable energy sources to mitigate these effects. However, there are energy storage problems associated with the continuous supply of electricity to consumers that power plants face when using renewable energy sources, such as those associated with concentrated solar power plants (CSP), wind turbines, and the like. For instance, the availability of renewables can be dependent upon various factors, such as the availability of the sun, wind, and the like. Also, there is a need for power plants using renewables to have energy storage systems, which are for the most part unavailable. Further, the heat-to-electricity conversion efficiency vary significant, with some systems being below 40% when integrating thermal energy storage (TES) systems into the power production grid.

There are currently three well-known methods of storing thermal energy, including latent heat (LH) storage occurring through the phase change of materials, thermochemical energy storage (TCES) based on reversible chemical reactions, and sensible heat storage (SHS) using the heat capacity of materials. A problem of any thermal energy storage system is the requirement of efficiency, dependency and environmentally friendliness on a large industrial scale. One problem with LH storage on a large industrial scale is the need to source the storage material that is used in the phase change, and the potential volume changes during phase transition. LH storage also suffers from poor charging and discharging performance subjected to the lower thermal conductivity of phase change materials and the inefficient heat transfer process. Because TCES systems rely upon thermochemical heat storage that works on chemical reactions that either absorb or release heat and rely upon those chemical reactions for storing heat energy or releasing heat energy, slow reaction kinetics, high cost, complex system design, potential material instability, and the need for significant heat transfer management can be problematic. The primary problem with sensible heat energy storage for thermal energy is its low energy density, meaning it requires a large volume of storage material to store a significant amount of heat, which can lead to large physical footprints and increased system costs compared to other thermal storage methods.

Conventional thermal energy storage systems often employ materials like graphite, molten salts, or phase-change materials. While effective, these materials can be expensive, environmentally challenging, and may have limitations regarding scalability, operational temperatures, and compatibility with various industrial processes.

Accordingly, there is a need in the industry for suitable thermal energy storage systems that provide adequate charging and discharging performance that are cost-effective and have a rather simple system design, provide material stability, have storage materials that are easily sourced and inexpensive, and provide efficient heat transfer for charging and discharging energy on a large scale, such as the Mega-Watt and Giga-Watt scale. There is also a need in the industry for sensible heat storage systems that can be efficiently charged to a desired thermal energy level to provide a source of stored energy without phase changes or chemical reactions during operation of the sensible heat storage medium, which stored energy can be efficiently discharged at a desired time of use.

### SUMMARY

The present disclosure is directed at a thermal energy storage system and related methods, more particularly a sensible heat storage system and related methods, whereby the thermal storage medium is a sensible heat storage medium comprising calcium oxide (CaO).

In some preferred aspects, the calcium oxide is generated from a source of calcium carbonate (CaCO₃). In some aspects the sensible heat storage medium comprising CaO is generated from the source of CaCO₃ in a storage vessel. In some aspects, the source of the CaCO₃ is limestone, such as limestone from a quarry. In some preferred aspects, the source of CaCO₃ produces CaO via a calcination process. In some other preferred aspects, pre-calcined CaO can be used directly in the system.

In some aspects, CaO is produced by calcining a source of CaCO₃ at a temperature of at least 650° C., in some aspects at least 700° C., in some aspects at least 750° C., in some aspects at least 800° C., in some aspects at least 850° C., in some aspects at least 900° C., and in some aspects at least 950° C. or more.

In some aspects the sensible heat storage medium, such as CaO, is provided in a storage vessel, whereby the sensible heat storage medium can be charged to a desired thermal temperature for storing thermal heat energy. The thermal heat energy stored in the sensible heat storage medium is capable of being discharged to efficiently transfer the thermal heat energy to a useful application. In some aspects, an input energy source can be used to charge the sensible heat storage medium to a desired thermal energy level to provide a source of stored energy. The stored energy can be discharged from the sensible heat storage medium by transferring at least a portion of the stored energy to an energy output source.

The charging process of the sensible heat storage medium can utilize various charging mechanisms, including, but not limited to, electrical heating elements, induction heating, hydrogen and oxygen combustion, solar thermal collectors, waste heat recovery, recycled heat from the discharging process, and other suitable heating technologies. During the charging process, the sensible heat storage medium comprising CaO absorbs thermal energy from the energy input source, such that the temperature of the sensible heat storage medium increases and is capable of being stored as sensible heat due to the high specific heat capacity of CaO. In some aspects, heating rates can be controlled based upon energy availability and storage capacity.

The discharge process of the stored energy in the sensible heat storage medium can employ various energy extraction mechanisms, including, but not limited to, passing a working fluid such as air, nitrogen, carbon dioxide, or one or more other suitable gases through the sensible heat storage medium to absorb thermal energy through direct contact, heat exchange systems that incorporate heat exchangers or thermal conduits within the storage vessel to transfer heat from the CaO to the working fluid without direct contact, thermophotovoltaic systems that utilize the intense light (photons) emitted by high-temperature CaO to generate electricity via thermophotovoltaic (TPV) cells, such that the TPV cells convert thermal radiation directly into electrical power, enhancing system efficiency and providing an additional method of energy extraction, direct heat transfer by directly transferring heat to a process or application, such as a reactor vessel or an industrial process line, and other energy extraction technologies that are suitable to discharging at least a portion of the stored energy from the sensible heat storage medium to an energy output source.

In some aspect, the heated working fluid or electricity generated from the discharging process can then be utilized in various applications, including, but not limited to industrial process heat that can be supply high-temperature heat for manufacturing processes, such as in biorefineries (e.g., ethanol production facilities), electricity generating by driving steam turbines, organic Rankine cycle systems, or using thermophotovoltaic conversion for direct electricity generation, space heating and cooling by providing thermal energy for heating or cooling buildings, including data centers, office buildings, and residential structures, combined heat and power application by simultaneously generating electricity and useful heat for increased overall efficiency, and any other application requiring thermal energy or electricity.

In some preferred aspects, a storage vessel filled with the sensible heat storage medium, such as CaO, is charged using a source of energy, such as surplus or off-peak electricity from renewable sources, that is converted into thermal energy by a thermal energy generator located within the storage vessel. In some aspects, the thermal energy generator is imbedded within the mass of the sensible heat storage medium. In some preferred aspects, the thermal energy generator comprises one or more joule heaters, induction heaters, plasma heaters, and the like. In some preferred aspects, the one or more joule heaters or induction heaters are embedded within the mass of the sensible heat storage medium. In some other aspects, the thermal energy generator is located adjacent the sensible heat storage medium. In some aspects, the thermal energy generator includes a fluidized boiler that is configured to charge the sensible heat storage medium.

In some preferred aspects, the storage vessel comprises a single-walled vessel configured from a metal material. In some other preferred aspects, the storage vessel comprises an outer wall and an inner wall with an annular void located between the outer and inner walls that is configured to allow the flow of a fluid between the outer and inner walls. The annular void can also provide an insulation cavity between the outer and inner walls. In some aspects, the storage vessel is configured to circulate air within the annular void between the outer and inner walls.

In some preferred aspects, during the process of discharging the thermal energy, a working fluid is passed in relation to the sensible heat storage medium to provide for the transfer of thermal energy from the sensible heat storage medium to the working fluid. In some aspects, the sensible heat storage medium is semi-porous, such that the working fluid is capable of passing at least partially through the sensible heat storage medium for the transfer of thermal energy.

In some preferred aspects, the heated working fluid can be used for various applications.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is a schematic diagram illustrating the sensible heat storage medium that is configured to undergo a charging process to a desired thermal energy temperature from an energy input source, and the sensible heat storage medium configured to undergo a discharging process to provide at least a portion of the stored energy to an energy output source, according to certain aspects of the present invention.

FIG. 2 is a schematic diagram of top cross-sectional view of a storage vessel having an outer wall, an inner wall and an annular void between the outer and inner walls, whereby the interior volume of the storage vessel at least partially filled with the sensible heat storage medium and having one or more thermal energy generators, whereby the sensible heat storage medium capable of being charged with thermal energy by the one or more thermal energy generators using the energy input source, and whereby the sensible heat storage medium capable of discharging at least a portion of the stored thermal energy to an energy output source, according to certain aspects of the present invention.

FIG. 3 is a schematic diagram of a top cross-sectional view of a storage vessel having the interior volume at least partially filled with the sensible heat storage medium and having one thermal energy generator, whereby the sensible heat storage medium during the charging process provides a temperature gradient radially extending from the thermal energy generator through a calcined zone and into an uncalcined zone, the darker color are signifying a higher thermal energy than the white area, and whereby the sensible heat storage medium capable of discharging at least a portion of the stored energy to an energy output source, according to certain aspects of the present invention.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

The thermal energy storage system and related methods of the present disclosure is directed to a sensible heat storage medium that is capable of being charged by providing thermal energy to the sensible heat storage medium that can be stored at a desired temperature for a desired period of time before the stored thermal energy is discharged to an energy output source for a desired use of the energy.

The term “sensible heat storage medium” as used herein refers to a material that can store thermal energy and is capable of changing its temperature without a change in its physical state. The increase in temperature of the material is substantially the result of charging the material from an input energy source, for example absorbing thermal energy, and not the result of a chemical reaction of the material with another component. The decrease in temperature of the material can be the result of the material cooling down or the result of discharging the stored energy to an output energy source.

The term “charging” as used herein in relation to the sensible heat storage medium refers to the mechanism of transferring energy from an input energy source to the material to increase the temperature of the material and provide stored energy.

The term “charged” as used herein refers to the sensible heat storage medium undergoing the charging process to provide at least a portion of stored energy from the input energy source.

The term “discharging” as used herein in relation to the sensible heat storage medium refers to the mechanism of transferring the stored energy from the material to an output energy source, which can decrease the temperature of the material if the charging mechanism is not simultaneously occurring.

The term “discharged” as used herein refers to the sensible heat storage medium undergoing the discharging process to have at least a portion of stored energy transferred to an output energy source.

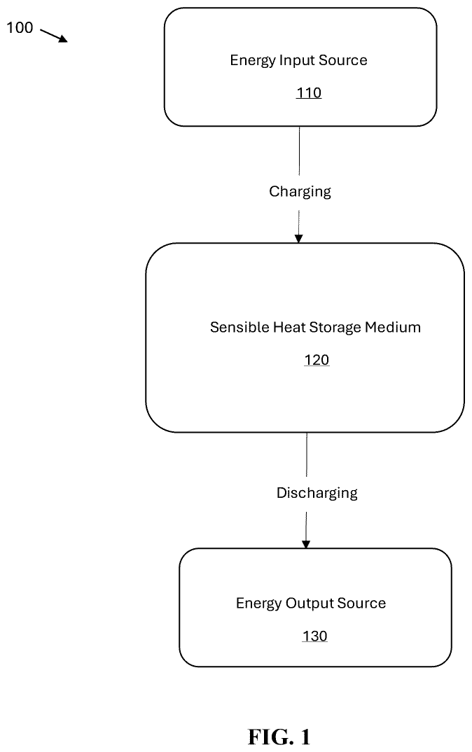

Referring now to FIG. 1, the thermal energy storage system 100 generally comprises an energy input source 110 for charging sensible heat storage medium 120 to the desired thermal energy level to provide a source of stored energy. The thermal heat energy stored in the sensible heat storage medium 120 is capable of being discharged to efficiently transfer the thermal heat energy from sensible heat storage medium 120 to an energy output source 130 for the useful application of the energy. At the most basic level, charging increases the thermal energy within sensible heat storage medium 120, and discharging decreases the thermal energy within sensible heat storage medium 120. In some preferred aspects, input energy source 110 can be used to charge the sensible heat storage medium 120 to a desired thermal energy level to provide a source of stored energy, which can be discharged from sensible heat storage medium 120 by transferring at least a portion of the stored energy to an energy output source 130.

The process of charging sensible heat storage medium 120 can utilize various energy input sources 110 having various charging mechanisms, including, but not limited to, electrical heating elements, induction heating, hydrogen and oxygen combustion, solar thermal collectors, waste heat recovery, recycled heat from the discharging process, and other suitable heating technologies. During the charging process, sensible heat storage medium 120 absorbs thermal energy from energy input source 110, such that the temperature of the sensible heat storage medium increases and is capable of being stored as sensible heat due to the high specific heat capacity of the material comprising sensible heat storage medium 120. In some aspects, heating rates can be controlled based upon energy availability and storage capacity.

The process of discharging stored energy in sensible heat storage medium 120 can employ various energy output sources 130 having various extraction mechanisms, including, but not limited to, passing a working fluid such as air, nitrogen, carbon dioxide, or one or more other suitable gases through the sensible heat storage medium to absorb thermal energy through direct contact, heat exchange systems that incorporate heat exchangers or thermal conduits within the storage vessel to transfer heat from sensible heat storage medium 120 to the working fluid without direct contact, thermophotovoltaic systems that utilize the intense light (limelight) emitted by the high-temperature material of sensible heat storage medium 120 to generate electricity via thermophotovoltaic (TPV) cells, such that the TPV cells convert thermal radiation directly into electrical power, enhancing system efficiency and providing an additional method of energy extraction, direct heat transfer by directly transferring heat to a process or application, such as a reactor vessel or an industrial process line, and other energy extraction technologies that are suitable to discharging at least a portion of the stored energy from the sensible heat storage medium to an energy output source.

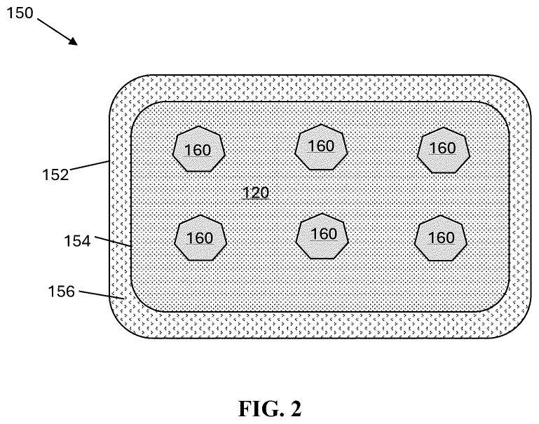

Sensible heat storage medium 120 is preferably contained within a storage vessel. Referring now to FIG. 2, an exemplary storage vessel 150 is shown containing sensible heat storage medium 120 within at least a portion of its interior volume. In some aspects, storage vessel 150 can include at least one wall. In some preferred aspects, storage vessel 150 includes an outermost wall 152 and an innermost wall 154 defining an annular void 156 between outermost wall 152 and innermost wall 154.

In some preferred aspects, annular void 156 can provide an insulation cavity to enhance thermal efficiency of sensible heat storage medium 120 within storage vessel 150. In some aspects, a fluid can be circulated within annular void 156, such as air, an inert gas, carbon dioxide, or the like. The annular void 156 having the circulated fluid provides a layer of insulation between outermost wall 152 and an innermost wall 154. In some preferred aspects, circulated fluid is air that can be preheated within annular void 156.

Sensible heat storage medium 120 can be any material capable of storing thermal energy without converting between phases during the charging and discharging processes. In some preferred aspects, sensible heat storage medium 120 is a solid metal oxide. In some preferred aspects, sensible heat storage medium 120 includes CaO. In some preferred aspects, sensible heat storage medium 120 comprises, and in some other aspects consists essentially of, CaO. CaO has a high specific heat capacity and thermal conductivity that enables efficient heat transfer.

In some aspects, CaO derived from abundant limestone through calcination, presents an opportunity for a cost-effective, scalable, and environmentally friendly thermal energy storage medium. CaO possesses a high specific heat capacity and thermal conductivity, making it suitable for efficient thermal energy storage without the need for phase changes or chemical reactions during operation. Additionally, CaO emits intense light at high temperatures, historically known as “limelight,” which photons can be harnessed for thermophotovoltaic energy conversion.

In some preferred aspects, sensible heat storage medium 120 includes CaO that is produced through initial CaCO₃ calcination, whereby the source of CaCO₃ is filled within the interior volume of storage vessel 150 and heated to a temperature to convert the CaCO₃ to CO₂ and CaO, whereby the CO₂ dissipates away leaving the storage vessel 150 at least partially filled with CaO. In some preferred aspects, the source of CaCO₃ comprises limestone, which in some applications can be sourced from a local quarry for filling storage vessel 150. In some aspects, storage vessel 150 filled with the source of CaCO₃, such as limestone, can be heated to a calcination temperature to convert the CaCO₃ to CO₂ and CaO.

In some preferred aspects, storage vessel 150 is filled with at least 1 tonne of CaO, in some aspects at least 2 tonnes of CaO, in some aspects at least 4 tonnes of CaO, in some aspects at least 5 tonnes of CaO, in some aspects at least 10 tonnes of CaO, in some aspects at least 100 tonnes of CaO, and in some aspects at least 1000 tonnes or more of CaO.

In some preferred aspects, storage vessel 150 is filled with at least 1 tonne of CaO₃, in some aspects at least 2 tonnes of CaO₃, in some aspects at least 4 tonnes of CaO₃, in some aspects at least 5 tonnes of CaO₃, in some aspects at least 10 tonnes of CaO₃, in some aspects at least 100 tonnes of CaO₃, and in some aspects at least 1000 tonnes or more of CaO₃, which can be at least partially calcined such that sensible heat storage medium 120 comprises, and in some other aspects consists essentially of, CaO.

In some preferred aspects, the calcination temperature to produce CaO from the source of CaCO₃ is over 825° C., in some aspects over 850° C., in some aspects over 875° C., in some aspects over 900° C., in some aspects over 925° C., in some aspects over 950° C., in some aspects over 975° C., and in some aspects over 1000° C.

In some preferred aspects, storage vessel 150 is primed to include sensible heat storage medium 120 by being filled with a source of CaCO₃ and undergoing calcination at least one time. In some other aspects, storage vessel 150 is primed to include sensible heat storage medium 120 by being filled with a source of CaCO₃ and undergoing a calcination process two or more times.

In some aspects, storage vessel 150 may need to undergo two or more cycles of being filled with the source of CaCO₃ and undergoing calcination to provide CaO before being properly primed. In some other aspects, storage vessel 150 after being properly primed and undergoing charging and discharging processes may need to be recharged by filling storage vessel 150 with the source of CaCO₃ and undergoing calcination to provide CaO.

In a preferred aspect, the system utilizes CaO as sensible heat storage medium. In some aspects, storage vessel 150 may contain a first portion of CaO and a second portion of CaO₃, whereby the first portion of CaO comprises the sensible heat storage medium 120. Storage vessel 150 containing the first portion of CaO and the second portion of CaO₃ may be the result of only a portion of the CaCO₃ being calcined to CaO during the calcination process. In some preferred aspects, CaO is produced by calcining limestone (calcium carbonate, CaCO₃) at temperatures typically between 900° C. and 1000° C. The calcination process decomposes CaCO₃ (such as limestone) into CaO and carbon dioxide (CO₂), such as shown in Scheme (1):

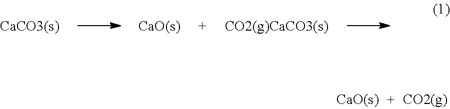

Alternatively, pre-calcined CaO can be sourced from suppliers and used directly in the system, allowing flexibility in implementation based on available resources. In some other alternative aspects, a first portion of pre-calcined CaO and a second portion of CaCO₃ can be provide in the system as a mixture, wherein the second portion of CaCO₃ may undergo a calcination process to convert at least a portion to CaO.

There are various advantages in utilizing CaO as the sensible heat storage medium 120, including, but not limited to:
High Specific Heat Capacity: CaO allows for significant energy storage per unit mass, making it efficient for large-scale applications;
High Thermal Conductivity: Facilitates efficient heat transfer during both charging and discharging processes;
Thermal Stability: Remains stable at high temperatures without undergoing phase changes or degradation, ensuring long-term reliability;
Intense Light Emission (Limelight): High-temperature CaO emits intense light, which can be harnessed using thermophotovoltaic systems for direct electricity generation.
Abundance and Low Cost: Limestone is one of the most abundant minerals on Earth, making CaO an inexpensive and readily available material;
Environmental Benefits: Reduces reliance on rare or hazardous materials, and the use of CaO may integrate with carbon capture and sequestration technologies, potentially offsetting CO₂ emissions from the calcination process; and/or
Compatibility with Industrial Processes: CaO is already used in various industries, making it a familiar material with established handling practices.

Once storage vessel 150 is substantially filed with sensible heat storage medium 120, energy input source 110 can be used for charging sensible heat storage medium 120 to a desired thermal energy temperature to provide a source of stored energy. In some aspects, the desired thermal energy temperature of sensible heat storage medium 120 at the fully charged state is at least 900° C. and up to 2800° C., in some aspects at least 925° C., in some aspects at least 950° C., in some aspects at least 975° C., and in some aspects at least 1000° C. In some preferred aspects, at least a portion of sensible heat storage medium 120 is charged to have a thermal energy temperature between about 900° C. and about 2800° C., in some aspects between 950° C. and about 2600° C., in some aspects between 975° C. and about 2400° C., and in some aspects between 1000° C. and about 2000° C.

Once storage vessel 150 has been charged to the desired thermal energy temperature to provide the source of stored energy, the source of stored energy in the sensible heat storage medium 120 can be discharged. In some preferred aspects, a portion of the source of stored energy in the sensible heat storage medium 120 is discharged. In some preferred aspects, the source of stored energy discharged from the sensible heat storage medium 120 is transferred to energy output source 140.

In some aspects, the thermal energy temperature of sensible heat storage medium 120 after at least a portion of the source of stored energy is discharged is less than the desired thermal energy temperature at the fully charged state.

In some preferred aspects, the thermal energy temperature of sensible heat storage medium 120 after the discharging process is less than 900° C., in some aspects less than 850° C., in some aspects less than 800° C., in some aspects less than 750° C., in some aspects less than 700° C., in some aspects less than 650° C., in some aspects less than 600° C., in some aspects less than 550° C., in some aspects less than 500° C., in some aspects less than 450° C., in some aspects less than 400° C., in some aspects less than 350° C., in some aspects less than 300° C., in some aspects less than 250° C., in some aspects less than 200° C., in some aspects less than 150° C., in some aspects less than 100° C., and in some aspects ambient temperature. In some preferred aspects, sensible heat storage medium 120 has a temperature less than 600° C. after the discharging process.

In some preferred aspects, the thermal energy temperature of sensible heat storage medium 120 after the discharging process is between ambient temperature and about 900° C., in some aspects between ambient temperature and about 850° C., in some aspects between ambient temperature and about 800° C., in some aspects between ambient temperature and about 750° C., in some aspects between ambient temperature and about 700° C., in some aspects between ambient temperature and about 650° C., in some aspects between ambient temperature and about 600° C., in some aspects between ambient temperature and about 550° C., in some aspects between ambient temperature and about 500° C., in some aspects between ambient temperature and about 450° C., in some aspects between ambient temperature and about 400° C., in some aspects between ambient temperature and about 350° C., in some aspects between ambient temperature and about 300° C., in some aspects between ambient temperature and about 250° C., in some aspects between ambient temperature and about 200° C., in some aspects between ambient temperature and about 150° C., and in some aspects between ambient temperature and about 100° C. In some preferred aspects, sensible heat storage medium 120 has a temperature between ambient temperature and about 600° C. after the discharging process.

Storage vessel 150 preferably is maintained at ambient temperature during the charging and discharging processes. In some preferred aspects, storage vessel 150 is provided on an industrial scale providing Megawatt-hours or even Gigawatt-hours. In some aspects, storage vessel 150 is provided on an industrial scale such that sensible heat storage medium 120 is charged to a state of having an equivalent of at least 1 Megawatt-hour, in some aspects at least 2 Megawatt-hours, in some aspects at least 5 Megawatt-hours, in some aspects at least 10 Megawatt-hours, in some aspects at least 100 Megawatt-hours, and in some aspects at least 1 Gigawatt-hour or more.

Storage vessel 150 can be constructed from materials capable of withstanding high temperatures and resisting chemical interactions with CaO, such as high-grade stainless steel alloys, refractory ceramics, or other suitable materials. Storage vessel 150 can be insulated to minimize heat loss and designed to accommodate varying quantities of CaO, including, but not limited to: large-scale applications (vessels containing at least 10 tons of CaO), medium-scale applications: (vessels containing at least 1 ton of CaO), small-scale applications (vessels containing at least 100 pounds of CaO), and/or micro-scale applications (vessels containing at least 1 pound of CaO). The vessel design may include features such as modular construction that allows scalability and ease of maintenance, integrated heat exchange elements that can facilitate efficient heat transfer during charging and discharging, radiation management systems that can incorporate materials and structures to harness emitted radiation and/or photons for thermophotovoltaic energy conversion, and/or safety mechanisms that can including pressure relief valves and temperature monitoring systems.

In some aspects, the desired thermal energy temperature of sensible heat storage medium 120 at the fully charged state is dependent upon the desired use of thermal energy. For example, the thermal energy storage system of the present disclosure may be utilized in combination with an ethanol plant whereby the desired temperature is between 1000° C. and about 1500° C. In some other aspects, the thermal energy storage system of the present disclosure may be utilized in combination with a cement plant whereby the desired temperature is between 1800° C. and about 2000° C. It is contemplated that various applications can use the stored energy of sensible heat storage medium 120 at various desired temperatures.

In some preferred aspects, sensible heat storage medium 120 is charged using one or more thermal energy generators 160 that uses energy input source 110 for generating thermal energy. The one or more thermal energy generators 160 can take various forms, including, but not limited to, joule heaters, induction heaters, hydrogen and oxygen combustion, solar thermal collectors, waste heat recovery, and other suitable heating technology. One of ordinary skill in the art will appreciate that the one or more thermal energy generators 160 may have a proximal temperature that is greater than the thermal energy level of sensible heat storage medium 120. For example, one or more thermal energy generators 160 may exert heat at a temperature greater than the fully charged state, whereby the fully charged state being between 900° C. and up to 2800° C., in some aspects at least 925° C., in some aspects at least 950° C., in some aspects at least 975° C., and in some aspects at least 1000° C.

In some aspects, the one or more thermal energy generators 160 are joule heaters or induction heaters. Joule heaters are preferably located at the bottom of storage vessel 150 and transfer the thermal energy that his generated to sensible heat storage medium 120 for storage thereof. In some aspects, each joule heater is at least partially embedded within sensible heat sensible heat storage medium 120, such as to provide for efficient thermal energy transfer. In some aspects, the one or more thermal energy generators 160 includes a fluidized boiler that is configured to transfer thermal energy to sensible heat storage medium 120 for storage thereof.

Energy input source 110 can comprise any source of electricity, thermal energy, or source of energy. In some preferred aspects, energy input source 110 comprises electricity produced from renewable sources. For example, energy input source 100 can comprise electricity produced from wind energy, solar energy, hydropower, bioenergy, geothermal energy, and the like. Renewable energy in this context means low- or zero-carbon footprint compared to energy produced from fossil fuels, such as coal, oil, and natural gas. In some preferred aspects, energy input source 110 comprises electricity produced from renewable sources during “off-peak” periods or curtailment of renewable energy. In some other aspects, energy input source 110 comprises electricity produced from nonrewable sources, such as the heat and/or electricity generated from the combustion of natural gas, coal, propane, butane and the like. Energy input source 110 may also be sourced from nuclear energy reactors.

In some other aspects, the sensible heat storage medium 120 can be heated by induction heating whereby electromagnetic fields are used to heat the sensible heat storage medium 120 or conductive elements within storage vessel 150.

In some other aspects, high-temperature heat can be produced within storage vessel 150 and transferred to the sensible heat storage medium 120 by the combustion of hydrogen and/or oxygen, whereby efficient storage of energy can be derived from electrolysis powered by an electrical source, such as renewables.

In some other aspects, solar thermal collectors can be utilized to concentrate solar power and generate high temperatures, which can be used to directly heat the sensible heat storage medium 120.

In some other aspects, waste heat can captured from a source, such as an industrial process or power generation facility, and used to heat the sensible heat storage medium 120.

As one of ordinary skill in the art can appreciate, essentially any suitable heating technology can be used as the energy source input, such that the thermal energy storage system 100 can be adaptable to various different types of heating technologies.

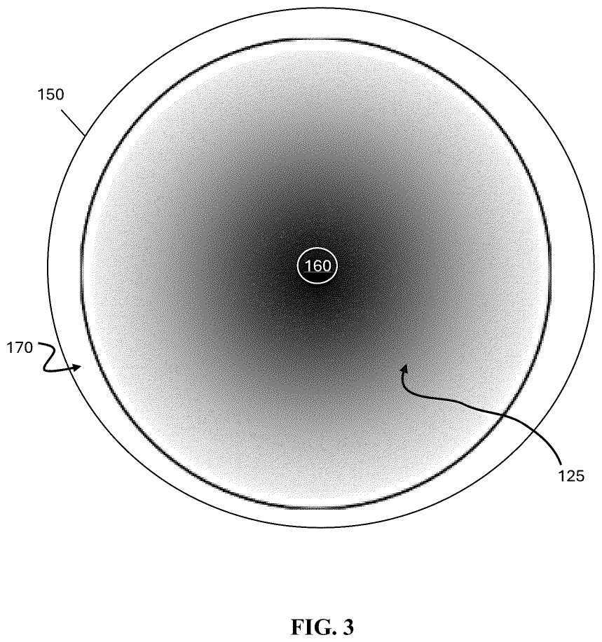

Referring now to FIG. 3, the charging of sensible heat storage medium 120 in storage vessel 150 using one or more thermal energy generators 160 can produce a temperature gradient emanating from each thermal energy generator 160. Specifically, sensible heat storage medium 120 during the charging process provides a temperature gradient radially extending from the thermal energy generator 160 through a calcined zone 125. For example, the temperature of sensible heat storage medium 120 at a first position located at thermal energy generator 160 would be greater than a second position located away from thermal energy generator 160. In some aspects, the temperature gradient can also extend into an uncalcined zone 170 surrounding sensible heat storage medium 120. Each storage vessel 150 may comprises one or more calcined zones 125 and one or more uncalcined zones 170. In some aspects, each calcined zone 125 comprises greater than 50%-wt CaO and less than 50%-wt CaO₃, while each uncalcined zone 170 comprises greater than 50%-wt CaO₃ and less than 50%-wt CaO.

In some aspects, calcined zone 125 comprises greater than 50% CaO, in some aspects greater than 55% CaO, in some aspects greater than 60% CaO, in some aspects greater than 65% CaO, in some aspects greater than 70% CaO, in some aspects greater than 75% CaO, in some aspects greater than 80% CaO, in some aspects greater than 85% CaO, in some aspects greater than 90% CaO, and in some aspects greater than 95% CaO, by weight-% of the material.

In some aspects, calcined zone 125 comprises greater than 50% CaO and less than 50% CaO₃, in some aspects greater than 50% CaO and less than 50% CaO₃, in some aspects greater than 55% CaO and less than 45% CaO₃, in some aspects greater than 60% CaO and less than 40% CaO₃, in some aspects greater than 65% CaO and less than 35% CaO₃, in some aspects greater than 70% CaO and less than 30% CaO₃, in some aspects greater than 75% CaO and less than 25% CaO₃, in some aspects greater than 80% CaO and less than 20% CaO₃, in some aspects greater than 85% CaO and less than 15% CaO₃, in some aspects greater than 90% CaO and less than 10% CaO₃, and in some aspects greater than 95% CaO and less than 5% CaO₃.

In some aspects, uncalcined zone 170 comprises greater than 50% CaO₃ and less than 50% CaO, in some aspects greater than 50% CaO₃ and less than 50% CaO, in some aspects greater than 55% CaO₃ and less than 45% CaO, in some aspects greater than 60% CaO₃ and less than 40% CaO, in some aspects greater than 65% CaO₃ and less than 35% CaO, in some aspects greater than 70% CaO₃ and less than 30% CaO, in some aspects greater than 75% CaO₃ and less than 25% CaO, in some aspects greater than 80% CaO₃ and less than 20% CaO, in some aspects greater than 85% CaO₃ and less than 15% CaO, in some aspects greater than 90% CaO₃ and less than 10% CaO, and in some aspects greater than 95% CaO₃ and less than 5% CaO.

In some aspects, the sensible heat storage medium 120 can produce thermal decomposition of materials within the storage vessel 150, such as the thermal decomposition of carbon dioxide into oxygen and carbon.

Stored energy within heat storage medium 120 can be transferred to any desirable energy output source 130 by discharging. In some aspects, thermal energy stored within heat storage medium 120 can be transferred to any desirable energy output source 130 by a discharging process that extracts thermal energy from the sensible heat storage medium 120 by a desired heat extraction mechanism. In some preferred aspects, the discharging process includes providing a working fluid that is capable of heat absorption and flowing the working fluid with respect to sensible heat storage medium 120 to transfer thermal energy from sensible heat storage medium 120 to the working fluid. In some aspects, at least a portion of working fluid can comprise the fluid located within annular void 156. In some preferred aspects, working fluid is first introduced at one end of storage vessel 150 and passed to the other end, such as from the bottom of storage vessel 150 to the top of storage vessel 150. In some preferred aspects, working fluid is passed through at least a portion of sensible heat storage medium 120. In some preferred aspects, sensible heat storage medium 120 is semi-porous, such that the working fluid can pass through at least a portion of the thermal mass of sensible heat storage medium 120.

The heated working fluid can then be transferred from sensible heat storage medium 120 within storage vessel 150 to another location, whereby the heated working fluid can be used as an energy output source 130 in various applications. For instance, heated working fluid can be used directly for a heat transfer application, converted to steam for the generation of electricity, or the like.

In some preferred aspects, the discharging process converts emitted radiation to electricity, or directly to a process, including, but not limited to, passing air or other gases through the CaO storage medium, thermophotovoltaic systems, heat exchange systems, or any other suitable energy extraction technologies.

In some other aspects, the heat exchange mechanism can include a heat exchange system that incorporates one or more heat exchangers or thermal conduits within the storage vessel 150 to transfer heat from the sensible heat storage medium 120 to the working fluid without direct contact.

In some other aspects, the heat exchange mechanism can include a thermophotovoltaic system that utilizes the intense light (photons) emitted by high-temperature CaO to generate electricity via thermophotovoltaic (TPV) cells. TPV cells can be used to convert thermal radiation directly into electrical power, enhancing system efficiency and providing an additional method of energy extraction.

In some other aspects, the heat exchange mechanism can include direct heat transfer whereby heat is transferred directly to a process or application, such as heating a reactor vessel or an industrial process line.

As one of ordinary skill in the art will appreciate, essentially any suitable technology can be utilized for discharging thermal energy from the sensible heat storage medium to the output energy source.

In some preferred aspects, the charging, thermal energy storage and discharging process occur without any phase changes or chemical reactions during normal operation.

While the foregoing disclosure relates to a single storage vessel 150 having sensible heat storage medium 120 that is configured for charging and discharging thermal energy, one of ordinary skill in the art will appreciate that the thermal energy storage system 100 of the present disclosure can have more than one storage vessel 150 having sensible heat storage medium 120, such that each storage vessel 150 having sensible heat storage medium 120 provides a charging and discharging thermal energy. In some aspects, the thermal energy storage system can have a plurality of storage vessels 150, each storage vessel 150 having sensible heat storage medium 120, such that the plurality of storage vessels 150 with the sensible heat storage medium 120 can provide a sequential cascade of thermal energy in the charging and/or discharging processes.

As an exemplary representation, a first storage vessel 150 having sensible heat storage medium 120 can be charged to a first thermal energy level and a second storage vessel 150 having sensible heat storage medium 120 can be charged to a second thermal energy level, whereby the second thermal energy level is greater than the first thermal energy level. During the discharging process, the working fluid can have a first thermal energy level during normal operation with the first storage vessel 150 having sensible heat storage medium 120 and then a subsequent second thermal energy level during normal operation with the second storage vessel 150 having sensible heat storage medium 120, such that the second thermal energy level of the working fluid is greater than the first thermal energy level.

As another exemplary representation, thermal energy storage system 100 comprises a first, second and third storage vessel 150, each having sensible heat storage medium 120, such that the sensible heat storage medium 120 of the first storage vessel 150 can be charged to a first thermal energy level, the sensible heat storage medium 120 of the second storage vessel 150 can be charged to a second thermal energy level, and the sensible heat storage medium 120 of the third storage vessel 150 can be charged to a third thermal energy level, whereby the second thermal energy level and/or the third thermal energy level is greater than the first thermal energy level. During the discharging process, the working fluid can have a first thermal energy level by virtue of the normal operable heat transfer interaction with the sensible heat storage medium 120 of the first storage vessel 150, a subsequent second thermal energy level by virtue of the normal operable heat transfer interaction with the sensible heat storage medium 120 of the second storage vessel 150, and a subsequent third thermal energy level by virtue of the normal operable heat transfer interaction with the sensible heat storage medium 120 of the third storage vessel 150. In some aspects, the second thermal energy level and/or third thermal energy level is greater than the first thermal energy level of the working fluid during the discharging process. In some aspects, the third thermal energy level of the working fluid during the discharging process is greater than the second thermal energy level, and the second thermal energy level is greater than the first thermal energy level.

In some aspects of the present invention, the sensible heat storage medium 120 of each storage vessel 150 can have thermal energy retention efficiency that is at least 90% over a period of 1 day and up to 7 days, in some aspects greater than 92%, in some aspects greater than 94%, in some aspects greater than 96%, in some aspects greater than 97%, in some aspects greater than 98%, in some aspects greater than 99%, and in some aspects greater than 99.5%, whereby the thermal energy retention efficiency relates to the efficiency of maintaining the thermal energy charge between the charging process and the discharging process.

In some preferred aspects, sensible heat storage medium 120 of each storage vessel 150 can maintain thermal energy retention such that there is less than 5% thermal energy over the course of 24 hours, in some aspects less than 4% thermal energy over the course of 24 hours, in some aspects less than 3% thermal energy over the course of 24 hours, in some aspects less than 2% thermal energy over the course of 24 hours, and in some aspects less than 1% thermal energy over the course of 24 hours.

In some aspects of the present invention, the sensible heat storage medium 120 of each storage vessel 150 can have a thermal energy to electricity conversion efficiency that is greater than 40%, in some aspects greater than 45%, in some aspects greater than 50%, in some aspects greater than 55%, in some aspects greater than 60%, and in some aspects greater than 65%, whereby the thermal energy to electricity conversion efficiency relates to the efficiency of converting the thermal energy of the sensible heat storage medium 120 to electricity during the discharging process.

In some preferred aspects, the discharging process includes a thermal energy transfer from sensible heat storage medium 120 to the working fluid, such that the discharging process consists essentially of a thermal energy to thermal energy transfer configuration.

In some preferred aspects, the discharging process includes a thermal energy transfer from sensible heat storage medium 120 to the working fluid and also a thermal photovoltaics energy conversion process, such that the discharging process includes both a thermal energy to thermal energy transfer configuration and also a thermal energy to electricity conversion configuration.

In some preferred aspects, working fluid is air, an inert gas, CO₂, or another gas or liquid that is capable of transferring thermal energy from sensible heat storage medium 120 to another location as an energy output source 130 for one or more desired applications needing thermal energy and/or electricity.

In some aspect, the heated working fluid or generated electricity from the sensible heat storage medium 120 from the discharging process can be utilized in various applications, including, but not limited to: industrial process heat whereby high-temperature heat can be supplied for manufacturing processes, such as in biorefineries (e.g., ethanol production facilities); electricity generation that can drive steam turbines, organic Rankine cycle systems, or using thermophotovoltaic conversion for direct electricity generation; space heating and cooling by providing thermal energy for heating or cooling buildings, including data centers, office buildings, and residential structures; and/or combined heat and power (CHP) whereby electricity and useful heat are simultaneously generated for increased overall efficiency. As one of ordinary skill in the art will appreciation, essentially any application requiring thermal energy or electricity can be adaptable or powered by the thermal energy storage system of the present disclosure.

The thermal energy storage system 100 of the present disclosure is designed for seamless integration with various energy sources and applications, including, but not limited to:
Renewable Energy Integration: Stores excess energy from renewable sources during periods of low demand or high production, such as off-peak wind power;
Industrial Facilities: Particularly suited for biorefineries, such as ethanol production plants, where the system can replace natural gas usage, reducing operational costs and emissions;
Data Centers: Provides heating or cooling needs while improving energy efficiency and reducing reliance on grid electricity during peak times;
Buildings: Office and residential buildings can utilize the system for heating and cooling applications, integrating with HVAC systems for improved energy management;
Grid Energy Storage: Offers load leveling and peak shaving capabilities for electrical grids, enhancing stability and reducing the need for peaking power plants;
Industrial Symbiosis: Facilitates the sharing of heat between different industrial processes, improving overall energy efficiency; and/or
Future Applications: The system is designed to accommodate new technologies and applications that may emerge, ensuring long-term relevance.

In an exemplary embodiment that includes a biofinery application, an ethanol production facility producing approximately 125 million gallons of ethanol per year can install a thermal energy storage system 100 with a storage vessel 150 containing at least 10 tons of CaO. The thermal energy storage system 100 can replace the use of natural gas, reducing consumption by approximately 7,800 therms per day. The CaO can be heated by one or more thermal energy generators 160, such as joule heating elements, powered by off-peak wind energy or via hydrogen and oxygen combustion derived from electrolysis using surplus renewable electricity. Air is passed through the heated CaO to extract the stored thermal energy, which is then used in the ethanol production process.

In another exemplary embodiment that includes thermophotovoltaic energy conversion, a power generation facility can install a thermal energy storage system 100 with a storage vessel 150 containing at least 1 ton of CaO. The CaO can be heated to high temperatures using one or more thermal energy generators 160, such as concentrated solar power or electrical heating elements. The intense light (limelight) emitted by the high-temperature CaO can be directed onto thermophotovoltaic cells, which converts the thermal radiation directly into electricity. This setup provides efficient energy storage and electricity generation without mechanical moving parts.

In another exemplary embodiment that includes hydrogen and oxygen combustion charging, an industrial plant can utilize surplus renewable energy to produce hydrogen and oxygen via electrolysis. The hydrogen and oxygen can be combusted to generate high-temperature heat, which can be used in a thermal energy storage system 100 with a storage vessel 150 to charge at least 1 ton of the sensible heat storage medium 120, such as CaO. The stored thermal energy can later be extracted by passing air through the CaO, providing process heat or generating steam for electricity production.

In another exemplary embodiment that includes data center cooling, a data center can install a thermal energy storage system 100 with a storage vessel 150 containing at least 100 pounds of CaO. The system can be charged using surplus renewable energy during off-peak hours, possibly using hydrogen and oxygen combustion for high-temperature heating. The stored thermal energy can be used to drive absorption chillers or other cooling systems during peak operation times, improving energy efficiency and reducing electricity costs.

As one of ordinary skill in the art will appreciate, the thermal energy storage system 100 of the present disclosure is designed to be compatible with any charging and discharging technologies that currently exist or that may be developed, including, but not limited to:
Advanced Heating Methods: Such as microwave heating, plasma heating, or other emerging technologies;
Novel Working Fluids: Including supercritical fluids, nanofluids, or other advanced heat transfer mediums;
Integration with Smart Grids: Allowing for automated charging and discharging based on grid demands and renewable energy availability;
Hybrid Systems: Combining thermal storage with other forms of energy storage, such as batteries or hydrogen production; and/or
Advanced Energy Conversion: Utilizing technologies like thermionic converters or other methods to harness the energy emitted by high-temperature CaO.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

1. A thermal energy storage system comprising:
a sensible heat storage medium contained within a storage vessel, the sensible heat storage medium comprising calcium oxide (CaO); and
an input energy source configured to be in operable connection with the sensible heat storage medium, wherein the input energy source is configured to charge the sensible heat storage medium to a desired thermal energy level to provide a source of stored energy.

2. The thermal energy storage system of claim 1, wherein the storage vessel is configured to contain at least 4 tonnes of CaO.

3. The thermal energy storage system of claim 1, wherein the sensible heat storage medium comprising a calcined zone comprising greater than 50 wt-% CaO.

4. The thermal energy storage system of claim 3, wherein the CaO is produced from the calcination of a source of calcium carbonate (CaO₃).

5. The thermal energy storage system of claim 4, wherein the source of CaO₃ comprises limestone.

6. The thermal energy storage system of claim 5, wherein the CaO is produced within the storage vessel by the calcination of CaO₃ contained in limestone.

7. The thermal energy storage system of claim 1, further comprising one or more thermal energy generators configured to generate thermal energy from the input energy source, wherein the one or more thermal energy generators is selected from the groups consisting of joule heaters, induction heaters and plasma heaters.

8. The thermal energy storage system of claim 1, wherein the energy input source comprises electricity, thermal energy, or a combination thereof.

9. The thermal energy storage system of claim 8, wherein the energy input source is a renewable energy source selected from the group consisting of wind energy, solar energy, hydropower, bioenergy, geothermal energy, nuclear energy, or a combination thereof.

10. The thermal energy storage system of claim 9, wherein the energy input source is configured to be produced from the renewable energy source during off-peak periods or curtailment of the renewable energy source.

11. The thermal energy storage system of claim 1, wherein the storage vessel comprises a single wall configuration or a double wall configuration, wherein the double wall configuration comprises an innermost wall and an outermost wall separated by an annular void, the annular void configured to receive circulated air therewithin.

12. The thermal energy storage system of claim 1, wherein the sensible heat storage medium is configured to be charged to a desired thermal energy level of at least 900° C. and up to 2800° C.

13. The thermal energy storage system of claim 1, wherein the sensible heat storage medium having a thermal energy retention efficiency of the source of stored energy that is at least 90% over a period of 1 day and up to 7 days.

14. The thermal energy storage system of claim 1, wherein the sensible heat storage medium can maintain thermal energy retention of the source of stored energy, such that there is less than 5% thermal energy loss of the source of stored energy over the course of 24 hours.

15. The thermal energy storage system of claim 1, further comprising an output energy source configured to be in operable connection with the sensible heat storage medium, wherein the output energy source is configured to receive at least a portion of the stored energy discharged from the sensible heat storage medium.

16. The thermal energy storage system of claim 15, further comprising a working fluid configured to be in operable connection with the sensible heat storage medium, wherein the working fluid is configured to transfer at least a portion of the stored energy discharged from the sensible heat storage medium to the energy output source.

17. A method for thermal energy storage, the method comprising:
optionally calcining a source of calcium carbonate to produce calcium oxide (CaO);
providing a sensible heat storage medium within a storage vessel, the sensible heat storage medium comprising a desired amount of CaO; and
charging the sensible heat storage medium from an energy input source to a desired thermal energy level to provide a source of stored energy.

18. The method of claim 17, further comprising filling the storage vessel with limestone, and conducting a calcination process on the limestone to produce the desired amount of CaO in the storge vessel.

19. The method of claim 18, wherein the steps of filling the storage vessel with limestone and conducting a calcination process on the limestone to produce CaO can be repeated two or more times to produce the desired amount of CaO within the storage vessel.

20. The method of claim 17, wherein one or more thermal energy generators are used to charge the sensible heat storage medium from the energy input source to the desired thermal energy level.

21. The method of claim 20, wherein the desired thermal energy level is at least 900° C. and up to 2800° C.

22. The method of claim 21, wherein the energy input source comprises electricity, thermal energy, or a combination thereof.

23. The method of claim 22, wherein the energy input source is a renewable energy source selected from the group consisting of wind energy, solar energy, hydropower, bioenergy, geothermal energy, nuclear energy, or a combination thereof.

24. The method of claim 23, wherein the energy input source is configured to be produced from a renewable energy source during off-peak periods or curtailment of the renewable energy source.

25. The method of claim 17, further comprising discharging at least of portion of the stored energy from the sensible heat storage medium to an energy output source.

26. The method of claim 25, wherein the storage energy is discharged from the sensible heat storage medium to an energy output source using a working fluid configured to be in operable connection between the sensible heat storage medium and the energy output source.
